(19) United States
(12) Patent Application Publication
(10) Pub. No.: US 2026/0188962 A1
(43) Pub. Date: Jul. 2, 2026

(54) PLUG ADAPTOR

(71) Applicant: Anker Innovations Technology Co., Ltd., CHANGSHA (CN)

(72) Inventor: Xianjie TANG, SHENZHEN (CN)

(21) Appl. No.: 19/541,497

(22) Filed: Feb. 17, 2026

Related U.S. Application Data
(63) Continuation of application No. 19/370,414, filed on Oct. 27, 2025.

(30) Foreign Application Priority Data
Dec. 31, 2024 (CN) 202411997240.3

(51) Int. Cl. H01R 31/06

(52) U.S. Cl. CPC H01R 31/06

(57) ABSTRACT

A plug adaptor, which includes a housing, a rotatable plug, a first slidable plug, a second slidable plug, a limiting assembly, and a locking assembly. The rotatable plug is rotatably connected to the housing via a rotating portion. The limiting assembly is capable of moving relative to the housing under an action of the rotatable plug or the first slidable plug. The locking assembly is capable of moving relative to the housing under an action of the first slidable plug or the second slidable plug. In a case where one of the rotatable plug, the first slidable plug, and the second slidable plug is in an in-use state, the other two of the rotatable plug, the first slidable plug, and the second slidable plug are in a retracted state, and the other two are locked in the retracted state by the limiting assembly and the locking assembly.

### CROSS-REFERENCE TO RELATED APPLICATION

The present application is a continuation application of U.S. patent application Ser. No. 19/370,414, which claims priority of Chinese Patent Application No. 202411997240.3, filed on Dec. 31, 2024, the entire contents of which are hereby incorporated by reference in their entirety.

### TECHNICAL FIELD

The present disclosure relates to the technical field of electrical equipment, specifically to a plug adaptor.

### BACKGROUND

Due to divergent plug standards and charging interface specifications across nations, the demand for unified global compatibility in business travel, overseas assignments, and international studies has driven the development of multi-standard plug adaptors.

However, in the related art, when one set of plugs is selected for use, the remaining sets of plugs can still be extended. This causes the other sets of plugs to accidentally extend and expose metal contacts, leading to user contact with the metal contacts and resulting in electric shock accidents, thereby increasing safety risks during user operation.

### SUMMARY OF THE DISCLOSURE

A plug adaptor, including:
a housing;
a rotatable plug, arranged on the housing and rotatably connected to the housing via a rotating portion;
a first slidable plug, arranged on the housing and capable of sliding relative to the housing;
a second slidable plug, arranged on the housing and capable of sliding relative to the housing;
a limiting assembly, arranged within the housing; wherein the limiting assembly is capable of moving relative to the housing under an action of the rotatable plug or the first slidable plug; and
a locking assembly, arranged within the housing; wherein the locking assembly is capable of moving relative to the housing under an action of the first slidable plug or the second slidable plug;
wherein in a case where one of the rotatable plug, the first slidable plug, and the second slidable plug is in an in-use state, the other two of the rotatable plug, the first slidable plug, and the second slidable plug are in a retracted state, and the other two are locked in the retracted state by the limiting assembly and the locking assembly.

A plug adaptor, including:
a housing;
a rotatable plug, arranged on the housing and rotatably connected to the housing;
a first slidable plug, arranged on the housing and capable of sliding relative to the housing;
a second slidable plug, arranged on the housing and capable of sliding relative to the housing;
a limiting assembly, arranged within the housing and capable of moving relative to the housing; and
a locking assembly, arranged within the housing and capable of moving relative to the housing; wherein,
in a case where the first slidable plug and the second slidable plug are in a retracted state and the rotatable plug switches from the retracted state to an in-use state, the limiting assembly and the locking assembly lock the first slidable plug and the second slidable plug in the retracted state;
in a case where the first slidable plug and the rotatable plug are in the retracted state and the second slidable plug switches from the retracted state to the in-use state, the limiting assembly and the locking assembly lock the first slidable plug and the rotatable plug in the retracted state;
in a case where the second slidable plug and the rotatable plug are in the retracted state and the first slidable plug switches from the retracted state to the in-use state, the limiting assembly locks the rotatable plug in the retracted state, and the locking assembly locks the second slidable plug in the retracted state.

A plug adaptor, including:
a housing;
a rotatable plug, arranged on the housing and rotatably connected to the housing via a rotating portion;
a first slidable plug, arranged on the housing and capable of sliding relative to the housing; and
a second slidable plug, arranged on the housing and capable of sliding relative to the housing;
wherein in a case where one of the rotatable plug, the first slidable plug, and the second slidable plug is in an in-use state, the other two of the rotatable plug, the first slidable plug, and the second slidable plug are in a retracted state.

### BRIEF DESCRIPTION OF THE DRAWINGS

To more clearly illustrate the technical solutions of the embodiments of the present disclosure or the related art, the following is a brief introduction to the drawings required for describing the embodiments or the related art. It is obvious that the drawings described below are only some embodiments of the present disclosure. For those skilled in the art, other drawings may be obtained based on these drawings without creative labor.

FIG. 1 is a structural schematic view of a plug adaptor according to some embodiments of the present disclosure.

FIG. 2 is an exploded view of a plug adaptor according to some embodiments of the present disclosure.

FIG. 3 is a structural schematic view of a limiting assembly, a locking member, a rotatable plug, a first slidable plug, and a second slidable plug according to some embodiments of the present disclosure.

FIG. 4 is a structural schematic view of the first slidable plug in FIG. 3 when in use.

FIG. 5 is a structural schematic view of a first limiting portion according to some embodiments of the present disclosure.

FIG. 6 is a structural schematic view of the second slidable plug in FIG. 3 when in use.

FIG. 7 is a structural schematic view of a first slidable plug according to some embodiments of the present disclosure.

FIG. 8 is partial enlarged view of FIG. 4 from another perspective.

### DETAILED DESCRIPTION

To make the purpose, technical solutions, and advantages of the present disclosure clearer, the following sections will provide a detailed description of the embodiments of the present disclosure with reference to the accompanying drawings.

In the following description, unless otherwise indicated, the same reference numerals denote the same or similar elements in different drawings. The embodiments described in the following exemplary embodiments do not represent all embodiments consistent with the present disclosure. On the contrary, they are merely examples of devices and methods consistent with some aspects of the present disclosure as detailed in the appended claims.

In the description of the present disclosure, it should be understood that terms such as “first,” “second,” etc. are intended for descriptive purposes only and should not be understood as indicating or implying relative importance. For those skilled in the art, the specific meaning of the above terms in the present disclosure can be understood based on the specific context. Furthermore, unless otherwise specified in the description of the present disclosure, “multiple” refers to two or more. “And/or” describes a relationship between associated objects, indicating that three relationships may exist, such as A and/or B, which may represent: A exists alone, A and B exist together, or B exists alone. The character “/” generally indicates that the associated objects before and after it are in an “or” relationship.

Unless otherwise defined, all technical and scientific terms used in the present disclosure have the same meanings as those generally understood by those skilled in the art. The terms used in this specification are intended solely to describe specific embodiments and are not intended to limit the scope of the present disclosure. The term “and/or” used herein includes all combinations of one or more of the listed items.

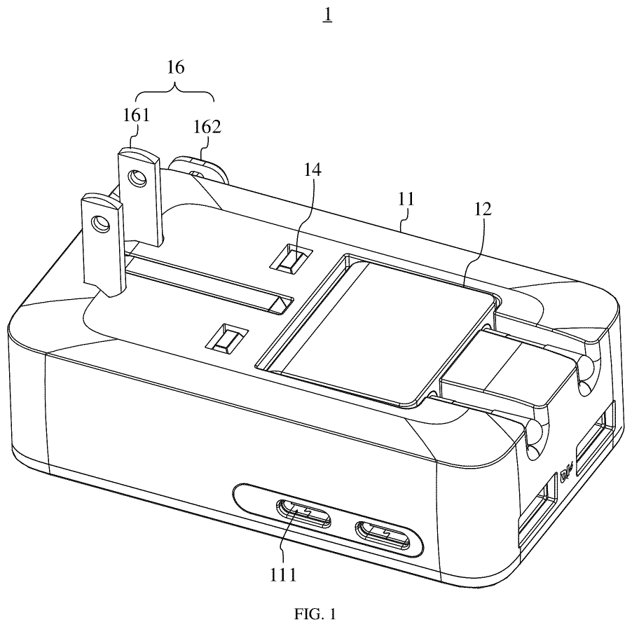

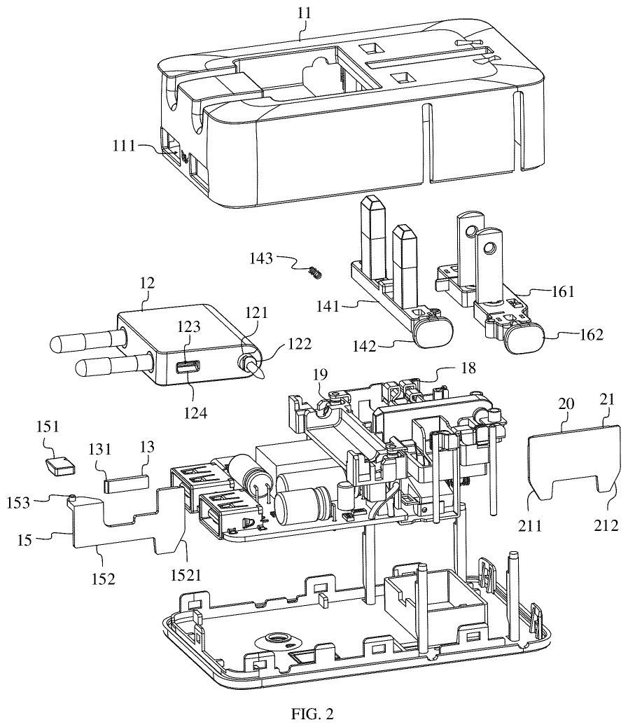

Referring to FIGS. 1 and 2, the present disclosure provides a plug adaptor 1, which includes a housing 11, a rotatable plug 12, a locking member 13, a first slidable plug 14, and a limiting assembly 15. The housing 11 may be made from various materials. For example, the housing 11 may be made of polycarbonate material, ABS material, or other insulating materials, without specific limitation herein. The housing 11 may have various shapes. For example, the housing 11 may be square, cylindrical, or other shapes, without specific limitation herein.

The rotatable plug 12 is arranged on the housing 11 and rotatably connected to the housing 11 via a rotating portion 121. It should be noted that when the rotatable plug 12 is in an in-use state, the rotatable plug 12 extends from the housing 11 to establish an electrical connection with an external socket. When the rotatable plug 12 is in a retracted state, the rotatable plug 12 is accommodated within an outer surface of the housing 11.

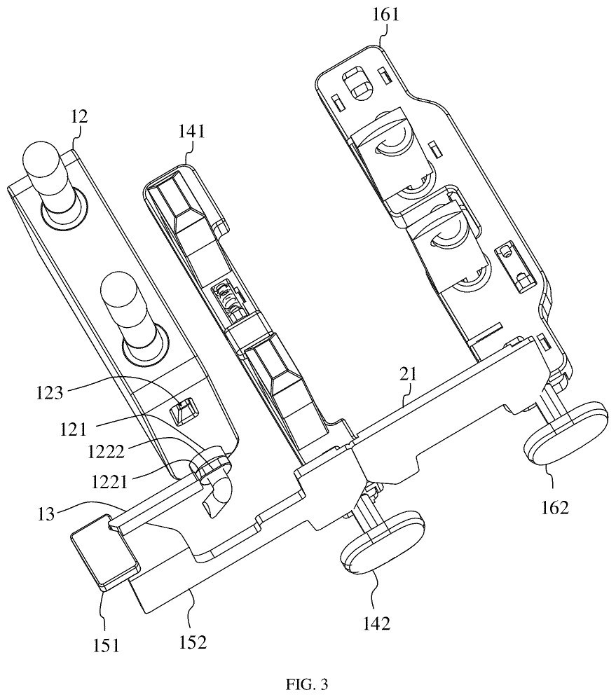

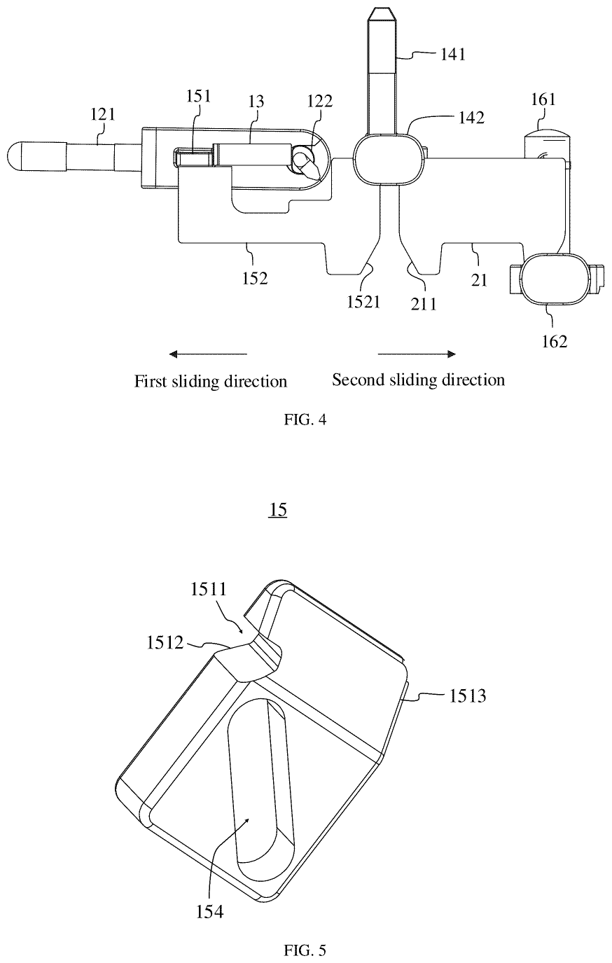

Further referring to FIGS. 3 and 4, the locking member 13 is arranged within the housing 11 and is in a transmission connection with the rotatable plug 12. The locking member 13 may be made of various materials. For example, the locking member 13 may be made of metal or plastic, and no specific limitations are imposed herein. In some embodiments, the locking member 13 is made of plastic, which may prevent the plug pins of the plug from coming into contact with the locking member 13 and causing a short circuit. The shape of the locking member 13 may vary. For example, the locking member 13 may be square, cylindrical, or other shapes, and no specific limitations are imposed herein. The locking member 13 may be arranged in the housing 11 in various ways. For example, the locking member 13 may be slidably arranged inside the housing 11 or rotatably arranged inside the housing 11, and no specific limitations are imposed herein. There are various ways in which the locking member 13 is connected to rotatable plug 12 for transmission. The locking member 13 and the rotatable plug 12 may abut against each other for transmission, or the locking member 13 and the rotatable plug 12 may be connected for transmission via gear and rack engagement, without specific limitation herein.

Further referring to FIGS. 3 and 4, the first slidable plug 14 is arranged on the housing 11 and capable of sliding vertically relative to the housing 11. When the first slidable plug 14 is in an in-use state, the first slidable plug 14 extends from the housing 11 to establish an electrical connection with an external socket. When the first slidable plug 14 is in a retracted state, the first slidable plug 14 may be retracted into an interior of the housing 11 or onto an outer surface of the housing 11, without any specific limitation herein.

Further referring to FIGS. 3 and 4, the limiting assembly 15 is arranged within the housing 11 and capable of moving horizontally relative to the housing 11. The limiting assembly 15 includes a first limiting portion 151 and a second limiting portion 152. The first limiting portion 151 is in a transmission connection with the second limiting portion 152. The first limiting portion 151 is in a transmission connection with the rotatable plug 12 via an abutment connection, and the second limiting portion 152 is in a transmission connection with the first slidable plug 14 via an abutment connection. It should be noted that when the first slidable plug 14 is in a retracted state and the rotatable plug 12 rotates from the retracted state to the in-use state, the rotatable plug 12 can drive the first limiting portion 151 to move, thereby driving the second limiting portion 152 to move and block the first slidable plug 14. Additionally, the rotatable plug 12 can drive the locking member 13 to move and lock the limiting assembly 15, thereby locking the first slidable plug 14 in the retracted state. When the rotatable plug 12 is in the retracted state and the first slidable plug 14 slides from the retracted state to the in-use state, the first slidable plug 14 can drive the second limiting portion 152 to move, thereby causing the first limiting portion 151 to slide and lock the rotatable plug 12 in the retracted state.

The first limiting portion 151 can slide along a direction parallel to the rotational shaft of the rotatable plug 12, or the first limiting portion 151 can slide along a direction forming an angle with the rotational shaft of the rotatable plug 12, without specific limitation herein. In some embodiments, the first limiting portion 151 slides along the direction parallel to the rotational shaft of the rotatable plug 12, thereby fully utilizing the space provided by the housing 11 around the rotational shaft of the rotatable plug 12.

The movement direction of the second limiting portion 152 may be the same as that of the first limiting portion 151, or the movement direction of the second limiting portion 152 may be set at an angle to that of the first limiting portion 151, without specific limitation herein. In some embodiments, the first limiting portion 151 slides along the direction parallel to the rotational shaft of the rotatable plug 12, and the movement direction of the second limiting portion 152 is perpendicular to the movement direction of the first limiting portion 151, which may reduce the space occupied by the first limiting portion 151 along the rotational shaft of the rotatable plug 12, while fully utilizing the space perpendicular to the rotational shaft of the rotatable plug 12 within the housing 11. As a result, the length of the housing 11 along the axial direction of the rotatable plug 12 is reduced, thereby minimizing the overall volume of the plug adaptor 1.

There are various ways for the locking member 13 to lock the limiting assembly 15. The locking member 13 may lock the limiting assembly 15 by engagement, or lock the limiting assembly 15 by insertion, without specific limitation herein.

There are various ways for the locking member 13 to release the locking of the limiting assembly 15. For example, when the rotatable plug 12 rotates from the in-use state to the retracted state, the locking member 13 releases the locking of the limiting assembly 15 under the drive of the rotatable plug 12. Alternatively, when the rotatable plug 12 rotates from the in-use state to the retracted state, the rotatable plug 12 releases the locking of the locking member 13, in which case, when the limiting assembly 15 slides to lock the rotatable plug 12, the limiting assembly 15 can drive the locking member 13 to slide. Specific details are not provided herein.

Referring to FIG. 4, when the rotatable plug 12 is in the retracted state and the first slidable plug 14 rotates from the retracted state to the in-use state, the first slidable plug 14 can drive the second limiting portion 152 to move linearly, causing the first limiting portion 151 to be in a limiting cooperation with the rotatable plug 12. It should be noted that when the first slidable plug 14 is in the in-use state, the first slidable plug 14 limits the second limiting portion 152, preventing the first limiting portion 151 from sliding, thereby keeping the first limiting portion 151 in a position that locks the rotatable plug 12 in the retracted state. When the first slidable plug 14 is in the retracted state, the first slidable plug 14 does not limit the second limiting portion 152, allowing the rotatable plug 12 to drive the first limiting portion 151 to slide and to switch to the in-use state.

There are various ways in which the first limiting portion 151 locks the rotatable plug 12. The first limiting portion 151 may lock the rotatable plug 12 by engagement, or lock the rotatable plug 12 by insertion. Specific details are not provided herein.

Referring to FIG. 3, when the first slidable plug 14 is in the retracted state and the rotatable plug 12 rotates from the retracted state to the in-use state, the rotatable plug 12 can drive the first limiting portion 151 to undergo linear displacement, causing the second limiting portion 152 to be in a limiting cooperation with the first slidable plug 14, and the rotating portion 121 drives the locking member 13 to move, causing the locking member 13 to be in a limiting cooperation with the limiting assembly 15. It should be noted that when the rotatable plug 12 is in the in-use state, the rotating portion 121 limits the locking member 13, keeping the locking member 13 in a position that locks the first limiting portion 151, thereby preventing the second limiting portion 152 from sliding and keeping the second limiting portion 152 in a position that locks the first slidable plug 14 in the retracted state. When the rotatable plug 12 is in the retracted state, the rotating portion 121 does not limit the locking member 13, allowing the locking member 13 to not limit the first limiting portion 151, thereby enabling the first slidable plug 14 to drive the second limiting portion 152 to slide and to switch to the in-use state.

There are various ways in which the second limiting portion 152 locks the first slidable plug 14, the second limiting portion 152 may partially extend into the sliding path of the first slidable plug 14 to block the first limiting assembly 15 from switching to the in-use state, or the second limiting portion 152 may be in an insertion cooperation with the first slidable plug 14 to block the first slidable plug 14 from switching to the in-use state. Specific details are not provided herein.

There are various ways to drive the locking member 13 to move. For example, when the rotatable plug 12 rotates from the in-use state to the retracted state, the rotating portion 121 drives the locking member 13 to move, thereby releasing the locking of the limiting assembly 15; or, when the first slidable plug 14 slides from the retracted state to the in-use state, the first slidable plug 14 drives the second limiting portion 152 to slide, thereby moving the first limiting portion 151, which in turn moves the locking member 13. These examples are not exhaustive.

Based on the plug adaptor 1 as proposed in the present disclosure, when the rotatable plug 12 is in the in-use state, the locking member 13 locks the first slidable plug 14 in the retracted state via the limiting assembly 15; when the first slidable plug 14 is in the in-use state, the limiting assembly 15 locks the rotatable plug 12 in the retracted state, thereby achieving mutual locking between the rotatable plug 12 and the first slidable plug 14. This may prevent one of the rotatable plug 12 and the first slidable plug 14 from accidentally extending when the other is in the in-use state, thereby avoiding electric shock accidents and enhancing the safety of the plug adaptor 1.

Further referring to FIGS. 3 and 4, in some embodiments of the present disclosure, the rotating portion 121 is arranged with a crank drive portion 122, which is disposed on a side of the rotatable plug 12 near the locking member 13 and arranged on the rotational shaft of the rotatable plug 12. When the first slidable plug 14 is in the retracted state and the rotatable plug 12 rotates from the retracted state to the in-use state, the crank drive portion 122 drives the locking member 13 to slide and lock the first limiting portion 151, thereby locking the first slidable plug 14 in the retracted state via the second limiting portion 152. This configuration effectively utilizes the space on the rotational shaft of the rotatable plug 12, while simplifying the transmission structure between the rotatable plug 12 and the locking member 13, thereby simplifying the structure of the plug adaptor 1.

It should be noted that, referring to FIG. 3, the crank drive portion 122 includes a drive segment 1221 and an avoidance segment 1222, with the distance between the drive segment 1221 and the rotational shaft of the rotatable plug 12 being greater than the distance between the avoidance segment 1222 and the rotational shaft of the rotatable plug 12. When the first slidable plug 14 is in the retracted state and the rotatable plug 12 rotates from the retracted state to the in-use state, the drive segment 1221 contacts the locking member 13 to drive the locking member 13 to move and lock the limiting assembly 15. When the rotatable plug 12 is in the retracted state, the avoidance segment 1222 faces the locking member 13 to provide sufficient movement space for the locking member 13 when the first slidable plug 14 switches from the retracted state to the in-use state.

Furthermore, referring to FIGS. 2 and 3, the rotatable plug 12 further includes a mating portion 123, which is arranged on the rotatable plug 12 and is disposed on the same surface as the crank drive portion 122 of the rotatable plug 12. When the rotatable plug 12 is in the retracted state and the first slidable plug 14 is in the in-use state, the limiting assembly 15 is in an insertion cooperation with the mating portion 123. This configuration ensures that the crank drive portion 122 and the mating portion 123 are positioned on the same surface of the rotatable plug 12, thereby ensuring that the limiting assembly 15 and the locking member 13 are both located on the same side of the rotatable plug 12, which may simplify the structure of the plug adaptor 1. Additionally, the mating portion 123 and the limiting assembly 15 are in the insertion cooperation, enabling the limiting assembly 15 to stably limit the rotation of the rotatable plug 12.

There are various ways in which the mating portion 123 and the limiting assembly 15 are in the insertion cooperation. For example, the mating portion 123 is a protrusion, and the limiting assembly 15 defines a groove that can be in the insertion cooperation with the protrusion; or, the mating portion 123 is a groove, and the limiting assembly 15 is inserted into the groove to form the insertion cooperation with the groove. These examples are not exhaustive.

Typically, the surface of the housing 11 is recessed to define an accommodation groove for accommodating the rotatable plug 12 in its retracted state. To protect the limiting assembly 15, the limiting assembly 15 is arranged in a mounting cavity within the housing 11. In this case, a wall of the accommodation groove defines a through hole for the limiting assembly 15 to extend through. When the mating portion 123 is a protrusion, to prevent interference between the mating portion 123 and walls of the accommodation groove when the rotatable plug 12 rotates, the wall of the accommodation groove with the through hole and the wall of the rotatable plug 12 with the mating portion 123 are spaced apart to define an avoidance channel. This arrangement causes the limiting assembly 15 to protrude from the avoidance channel when it is inserted into the mating portion 123. Therefore, in some embodiments, the mating portion 123 is configured as a recess, and the limiting assembly 15 can be inserted into the recess to form an insertion cooperation with the recess, such that the wall of the accommodation groove with the through hole and the wall of the rotatable plug 12 with the mating portion 123 are closely arranged, thereby reducing the exposed area of the limiting assembly 15 when the limiting assembly 15 is inserted into the mating portion 123, and thus better protecting the limiting assembly 15 while optimizing the appearance of the rotatable plug 12. To facilitate the rotation of the rotatable plug 12 to drive the first limiting portion 151, the recess is arranged with a drive slope 124. An end of the first limiting portion 151 for extending into the recess is arranged with an abutment slope 1513. When the rotatable plug 12 switches from the retracted state to the in-use state, the drive slope 124 mates with the contact slope 1513, causing the first limiting portion 151 to retract from the groove.

Specifically, referring to FIGS. 2, 3, and 5, the first limiting portion 151 defines a locking slot 1511 recessed on an end near the locking member 13. When the first slidable plug 14 is in the retracted state and the rotatable plug 12 is in the in-use state, the locking member 13 is in an insertion cooperation with the locking slot 1511 to lock the first slidable plug 14 in the retracted state. With this configuration, the locking slot 1511 is provided at the end of the first limiting portion 151 near the locking member 13, thereby shortening the travel distance of the locking member 13. Additionally, the insertion cooperation between the locking member 13 and the locking slot 1511 ensure a stable positioning of the first limiting portion 151. It can be understood that when the first slidable plug 14 is in the in-use state, the locking slot 1511 is misaligned with the locking member 13, preventing the locking member 13 from entering the locking slot 1511, thereby preventing the locking member 13 from limiting the first limiting portion 151.

There are various ways for the locking member 13 to exit the locking slot 1511. For example, the locking member 13 may exit the locking slot 1511 driven by the rotatable plug 12, or may exit the locking slot 1511 driven by the first limiting portion 151. Specific details are not provided herein. The position of the locking slot 1511 is related to the movement of the locking member 13. For example, when the locking member 13 can slide relative to the housing 11, the locking slot 1511 is defined on a surface of the first limiting portion 151 facing the locking member 13; or, when the locking member 13 can rotate relative to the housing 11, an end of the locking member 13 near the first limiting portion 151 can move in an up and down direction, and the locking slot 1511 is defined on a surface of the rotatable plug 12 in the up and down direction. These examples are not exhaustive. It should be noted that when the locking member 13 can rotate relative to the housing 11, the rotational shaft of the rotatable plug 12 and the first limiting portion 151 may be disposed on the same side of the rotational shaft of the locking member 13, or the rotational shaft of the rotatable plug 12 and the first limiting portion 151 may be disposed on opposite sides of the rotational shaft of the locking member 13, which is not specifically limited herein.

Furthermore, referring to FIG. 5, an end of the locking member 13 near the first limiting portion 151 is arranged with a guide slope 131, and a surface of locking slot 1511 facing the guide slope 131 is arranged with a matching slope 1512. When the rotatable plug 12 is in the retracted state and the first slidable plug 14 slides from the retracted state to the in-use state, the first slidable plug 14 can drive the second limiting portion 152 to slide, thereby driving the first limiting portion 151 to slide. The first limiting portion 151, through the matching slope 1512, mates with the guide slope 131 to drive the locking member 13 to exit the locking slot 1511. With this configuration, when the rotatable plug 12 is in the retracted state and the first slidable plug 14 slides from the retracted state to the in-use state, the first limiting portion 151 can drive the locking member 13 to exit the locking slot 1511. In this way, there is no need to include a structure for enabling the rotatable plug 12 to drive the locking member 13 to exit the locking slot 1511, thereby simplifying the structure of the plug adaptor 1.

Further referring to FIGS. 2 and 5, in some embodiments of the present disclosure, one of the first limiting portion 151 and the second limiting portion 152 is arranged with a drive portion 153, while the other of the first limiting portion 151 and the second limiting portion 152 defines an inclined sliding slot 154. The drive portion 153 extends into the inclined sliding slot 154, thereby enabling the first limiting portion 151 and the second limiting portion 152 to be connected in a transmission manner via the drive portion 153 and the inclined sliding slot 154. With this configuration, extending the drive portion 153 into the inclined sliding slot 154 can connect the first limiting portion 151 and the second limiting portion 152 in a transmission connection, thereby simplifying the transmission structure between the first limiting portion 151 and the second limiting portion 152. In addition, the mating between the inclined sliding slot 154 and the drive portion 153 allows the first limiting portion 151 and the second limiting portion 152 to slide along two intersecting directions.

It can be understood that the extension direction of the inclined sliding slot 154 includes the movement direction of the first limiting portion 151 and the movement direction of the second limiting portion 152. When the first limiting portion 151 is arranged with the drive portion 153, then the second limiting portion 152 defines the inclined sliding groove 154; when the first limiting portion 151 defines the inclined sliding groove 154, then the second limiting portion 152 is arranged with the drive portion 153.

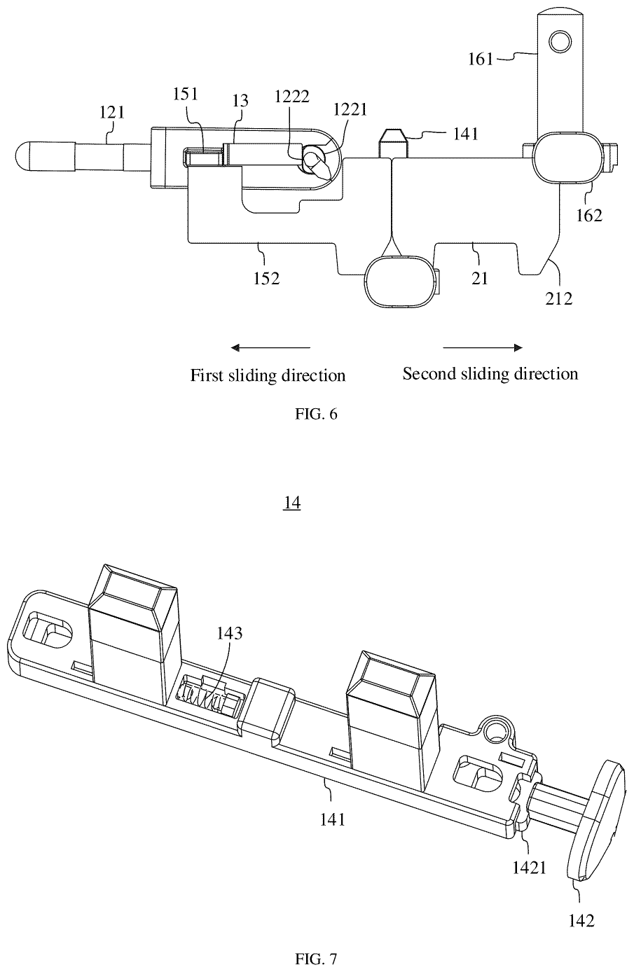

Referring to FIGS. 2 and 6, in some embodiments of the present disclosure, the plug adaptor 1 further includes a second slidable plug 16 and a locking assembly 20, and the second slidable plug 16 is arranged on the housing 11 and capable of sliding vertically relative to the housing 11; the locking assembly 20 is in a transmission connection with the rotatable plug 12, the first slidable plug 14, and the second slidable plug 16.

When one of the rotatable plug 12, the first slidable plug 14, and the second slidable plug 16 is in the in-use state, the other two are in the retracted state, and the other two are locked in the retracted state by the limiting assembly 15. Such a configuration enhances the practicality of the plug adaptor 1 by incorporating the second slidable plug 16, while also enabling the interlocking of the rotatable plug 12, first slidable plug 14, and second slidable plug 16, thereby preventing accidental extension of the other two when one of the rotatable plug 12, first slidable plug 14, and second slidable plug 16 is in use, thus enhancing the safety of the plug adaptor 1.

It should be noted that the second slidable plug 16 may be disposed on a side of the rotatable plug 12 near the first slidable plug 14, or the second slidable plug 16 may be disposed on a side of the rotatable plug 12 opposite the first slidable plug 14. No specific limitations are imposed herein.

There are various ways to achieve interlocking between the rotatable plug 12, the first slidable plug 14, and the second slidable plug 16 through the cooperation of the limiting assembly 15 and the locking assembly 20.

For example, the locking assembly 20 includes a first locking block and a second locking block. The first locking block is in a transmission connection with the rotatable plug 12 and the second slidable plug 16, and the second locking block is in a transmission connection with the first slidable plug 14 and the second slidable plug 16. When the rotatable plug 12 switches from the retracted state to the in-use state, the rotatable plug 12 drives the first locking block to slide and lock the second slidable plug 16 in the retracted state. When the first slidable plug 14 switches from the retracted state to the in-use state, the first slidable plug 14 drives the second locking block to slide and lock the second slidable plug 16 in the retracted state. When the second slidable plug 16 switches from the retracted state to the in-use state, the second slidable plug 16 drives the first locking block to slide and lock the rotatable plug 12 in the retracted state, and the second slidable plug 16 drives the second locking block to slide and lock the first slidable plug 14 in the retracted state.

Alternatively, the limiting assembly 15 further includes a first locking block, which is in a transmission connection with the second slidable plug 16. When the rotatable plug 12 switches from the retracted state to the in-use state, the rotatable plug 12 drives the first limiting portion 151 to slide and lock the second slidable plug 16 in the retracted state. When the first slidable plug 14 switches from the retracted state to the in-use state, the first slidable plug 14 drives the first locking block to slide and lock the second slidable plug 16 in the retracted state. When the second slidable plug 16 switches from the retracted state to the in-use state, the second slidable plug 16 drives the first limiting portion 151 to slide and lock the rotatable plug 12 in the retracted state, and the second slidable plug 16 drives the first locking block to slide and lock the first slidable plug 14 in the retracted state. These examples are not exhaustive.

In some embodiments, the locking assembly 20 includes a locking portion 21, the first limiting portion 151 is disposed within the housing 11 and is in a transmission connection with the rotatable plug 12; the second limiting portion 152 is arranged in the housing 11 and slidable relative to the housing 11, and is in a transmission connection with the first limiting portion 151 and the first slidable plug 14; the locking portion 21 is arranged in the housing 11 and is in a transmission connection with the first slidable plug 14, the second slidable plug 16, and the second limiting portion 152.

When the rotatable plug 12 is in the in-use state, the first limiting portion 151 locks the first slidable plug 14 in the retracted state, the second limiting portion 152 abuts against the locking portion 21, and the locking portion 21 locks the second slidable plug 16 in the retracted state. When the first slidable plug 14 is in the in-use state, the first limiting portion 151 locks the rotatable plug 12 in the retracted state, and the locking portion 21 locks the second slidable plug 16 in the retracted state. When the second slidable plug 16 is in the in-use state, the locking portion 21 abuts against the second limiting portion 152, the second limiting portion 152 locks the second slidable plug 16 in the retracted state, and the first limiting portion 151 locks the rotatable plug 12 in the retracted state.

This configuration may achieve the interlocking of the rotatable plug 12, the first slidable plug 14, and the second slidable plug 16, thereby preventing accidental extension of the other two when one of the rotatable plug 12, first slidable plug 14, and second slidable plug 16 is in use, thus enhancing the safety of the plug adaptor 1. Additionally, the second slidable plug 16 can slide along the drive locking portion 21 to abut against the second limiting portion 152, thereby moving the second limiting portion 152, which simplifies the transmission structure for locking the rotatable plug 12 by the second slidable plug 16, simplifying the structure of the plug adaptor 1.

Specifically, the first slidable plug 14 is disposed between the rotatable plug 12 and the second slidable plug 16, and the first slidable plug 14 is disposed between the second limiting portion 152 and the locking portion 21. The second limiting portion 152 and the locking portion 21 are both disposed on the same side of the rotational shaft of the rotatable plug 12, and the locking portion 21 and the second limiting portion 152 can both slide along a first sliding direction and a second sliding direction, which are opposite to each other.

Referring to FIG. 3, when the rotatable plug 12 rotates from the retracted state to the in-use state, the rotatable plug 12 drives the first limiting portion 151 to slide, thereby driving the second limiting portion 152 to slide along the second sliding direction. The second limiting portion 152 abuts against the locking portion 21, causing the second limiting portion 152 to drive the locking portion 21 to slide along the second sliding direction to block the second slidable plug 16, and the rotatable plug 12 can drive the locking member 13 to lock the first limiting portion 151, preventing the second limiting portion 152 and the locking portion 21 from moving. As a result, the second limiting portion 152 and the locking portion 21 lock the first slidable plug 14 and the second slidable plug 16 in the retracted state, respectively.

Referring to FIG. 4, when the first slidable plug 14 slides from the retracted state to the in-use state, the first slidable plug 14 drives the locking portion 21 to slide along the second sliding direction to lock the second slidable plug 16 in the retracted state, and the first slidable plug 14 drives the second limiting portion 152 to slide along the first sliding direction, thereby moving the first limiting portion 151 to lock the rotatable plug 12 in the retracted state.

Referring to FIG. 6, when the second slidable plug 16 slides from the retracted state to the in-use state, the second slidable plug 16 drives the locking portion 21 to slide along the first sliding direction and lock the first slidable plug 14 in the retracted state. The locking portion 21 abuts against the second limiting portion 152, causing the second limiting portion 152 to slide along the first sliding direction. The second limiting portion 152 drives the first limiting portion 151 to slide, thereby locking the rotatable plug 12 in the retracted state.

For clarity, two plug pins of the first slidable plug 14 are arranged along a first width direction, and two pins of the second slidable plug 16 are arranged along a second width direction. In some embodiments, the first width direction is parallel to the second width direction, thereby avoiding interference between the first slidable plug 14 and the second slidable plug 16, while further making the appearance of the plug adaptor 1 more aesthetically pleasing. The first width direction and the second width direction may both be perpendicular to the rotational shaft of the rotatable plug 12, or they may both be parallel to the rotational shaft of the rotatable plug 12. No specific limitation is imposed herein.

In some embodiments, referring to FIG. 1, the first limiting portion 151 is disposed between the rotatable plug 12 and the locking portion 21, and the first width direction and the second width direction are both parallel to the rotational shaft of the rotatable plug 12. In this case, the rotatable plug 12, the first slidable plug 14, and the second slidable plug 16 are arranged in sequence along a direction perpendicular to the first width direction and the second width direction. This design makes the appearance of the plug adaptor more aesthetically pleasing. Additionally, the first limiting portion 151, the second limiting portion 152, and the locking portion 21 are all disposed on the same side of the first slidable plug 14 in the first width direction, thereby reducing the space occupied by the limiting assembly 15, facilitating its design, and consequently reducing the volume of the plug adaptor 1 and simplifying its structure.

Referring to FIG. 2, the first slidable plug 14 includes a first slidable plug body 141 and a first drive member 142. The first slidable plug body 141 is arranged in the housing 11 and is slidable relative to the housing 11. The first drive member 142 is in a transmission connection with the first slidable plug body 141 and partially extends outside the housing 11. The second slidable plug 16 includes a second slidable plug body 161 and a second drive member 162. The second slidable plug body 161 is arranged in the housing 11 and is slidable relative to the housing 11. The second drive member 162 is in a transmission connection with the second slidable plug body 161 and partially extends outside the housing 11.

Referring to FIG. 3, when the rotatable plug 12 is in the in-use state, the second limiting portion 152 blocks the first drive member 142, and the locking portion 21 blocks the second drive member 162, thereby locking the first slidable plug 14 and the second slidable plug 16 in the retracted state.

Referring to FIG. 4, when the first slidable plug 14 is in the in-use state, the locking portion 21 blocks the second drive member 162, thereby locking the second slidable plug 16 in the retracted state.

Referring to FIG. 6, when the second slidable plug 16 is in the in-use state, the locking portion 21 blocks the first drive member 142, thereby locking the first slidable plug 14 in the retracted state.

With this configuration, the user may drive the first slidable plug body 141 and the second slidable plug body 161 to slide by respectively actuating the portions of the first drive member 142 and the second drive member 162 that extend out of the housing 11, thereby facilitating the user to switch the first slidable plug 14 and the second slidable plug 16 between the in-use state and the retracted state, and thus facilitating the use of the plug adaptor 1. In addition, the second limiting portion 152 and the locking portion 21 can lock the first slidable plug 14 in the retracted state by blocking the first drive member 142, and the locking portion 21 can lock the second slidable plug 16 in the retracted state by blocking the second drive member 162, thereby simplifying the structure of the limiting assembly 15.

Specifically, referring to FIG. 3, when the plug adaptor 1 is in the in-use state, the locking member 13 is limited by the rotatable plug 12, and the locking member 13 limits the first limiting portion 151. Since the first limiting portion 151 is in a transmission connection with the second limiting portion 152 and the first limiting portion 151 is limited, the second limiting portion 152 cannot move. The second limiting portion 152 blocks the first drive member 142 and limits the locking portion 21, which in turn blocks the second drive member 162.

Referring to FIG. 4, when the first slidable plug 14 is in the in-use state, the first drive member 142 limits the second limiting portion 152. Since the first limiting portion 151 is in a transmission connection with the second limiting portion 152 and the second limiting portion 152 is limited, the first limiting portion 151 cannot move. The first limiting portion 151 limits the rotatable plug 12, the first drive member 142 limits the locking portion 21, and the locking portion 21 blocks the second drive member 162.

Referring to FIG. 6, when the second slidable plug 16 is in the in-use state, the second drive member 162 limits the locking portion 21 and limits the second limiting portion 152 through the locking portion 21, and the locking portion 21 blocks the first drive member 142. Since the first limiting portion 151 is in a transmission connection with the second limiting portion 152 and the second limiting portion 152 is limited, the first limiting portion 151 cannot move, and the first limiting portion 151 limits the rotatable plug 12.

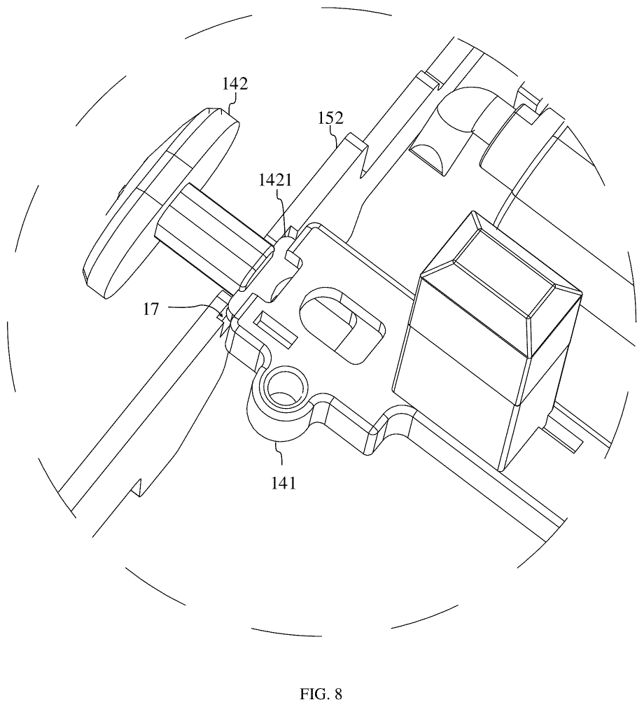

Furthermore, referring to FIGS. 7 and 8, the first drive member 142 is arranged on the first slidable plug body 141 and is slidable relative to the first slidable plug body 141 to switch between an unlocked position and a locked position. When the first slidable plug 14 is in the in-use state and the first drive member 142 is in the locked position, the first drive member 142 mates with the second limiting portion 152 and/or the locking portion 21 to lock the first slidable plug body 141 in the in-use state. When the first drive member 142 is in the unlocked position, the first slidable plug 12 can switch between the retracted state and the in-use state. This configuration prevents the first slidable plug 12 from switching from the in-use state to the retracted state when the plug adaptor 1 is shaken, thereby facilitating user operation of the plug adaptor 1.

It should be noted that when the first slidable plug 14 is in the in-use state, the second limiting portion 152 and the locking portion 21 are required to be limited. The first slidable plug 14 limits the second limiting portion 152 and the locking portion 21, and the first slidable plug 14 mates with the second limiting portion 152 and/or the locking portion 21 to lock the first slidable plug body 141 in the in-use state. There are various ways to achieve the above, but for the sake of clarity, it is hereby defined that the first slidable plug 14 slides upward to switch to the in-use state, and the first slidable plug 14 slides downward to switch to the retracted state.

For example, the first drive member 142 is arranged with a latching portion and an engaging portion disposed above the latching portion. When the first slidable plug 14 is in the in-use state and the first drive member 142 is in the locked position, the latching portion is located between the second limiting portion 152 and the locking portion 21, thereby limiting the second limiting portion 152 and the locking portion 21, and the engaging portion is engaged above the second limiting portion 152 and/or the locking portion 21 to limit the downward sliding of the first drive member 142, thereby locking the first slidable plug body 141 in the in-use state.

Alternatively, the first drive member 142 is arranged with a restricting portion 1421, the second limiting portion 152 and/or the locking portion 21 define a limiting slot 17, and the restricting portion 1421 mates with the limiting slot 17 to limit the second limiting portion 152 and the locking portion 21, while limiting the downward sliding of the first driving member 142, thereby locking the first slidable plug body 141 in the in-use state. These examples are not exhaustive.

In some embodiments, referring to FIGS. 7 and 8, the first drive member 142 is arranged with a restricting portion 1421, and the second limiting portion 152 and/or the locking portion 21 define a limiting slot 17. When the first slidable plug 14 is in the in-use state and the first drive member 142 is in the locked position, the restricting portion 1421 is in an insertion cooperation with the limiting slot 17. When the first drive member 142 switches from the locked position to the unlocked position, the restricting portion 1421 exits the limiting slot 17 to release the limitation on the first drive member 142, thereby allowing the first slidable plug 14 to switch to the retracted state. In this way, the insertion cooperation between the restricting portion 1421 and the limiting slot 17 can limit the second limiting portion 152 and the locking portion 21, as well as the first drive member 142, thereby simplifying the structure of the plug adaptor 1.

When the first slidable plug 14 is in the in-use state and the first drive member 142 is in the locked position, the restricting portion 1421 is in an insertion cooperation with the limiting slot 17. When the first slidable plug 14 is required to slide into the retracted state, the first drive member 142 may first be switched to the unlocked position, causing the restricting portion 1421 to disengage from the limiting slot 17, thereby allowing the first slidable plug body 141 to be driven by the first drive member 142 to slide, thus preventing the first slidable plug 14 from switching from the in-use state to the retracted state when the plug adaptor 1 is shaken, thereby facilitating user operation of the plug adaptor 1.

In some embodiments of the present disclosure, the first slidable plug 14 further includes an elastic member 143, an end of the elastic member 143 abutting against the first slidable plug body 141, and the other end of the elastic member 143 abutting against the first drive member 142, such that the first drive member 142 tends to switch from the unlocked position to the locked position. With this arrangement, the elastic member 143 can keep the restricting portion 1421 stably in the locked position, thereby enabling the first slidable plug 14 to remain stable in the in-use state, thus facilitating user operation of the plug adaptor 1.

It should be noted that the first drive member 142 is sequentially arranged with a drive portion, a connection portion, a restricting portion 1421, and a transmission portion. The drive portion extends out of the housing, and the transmission portion is in a transmission connection with the first slidable plug body 141. Since the restricting portion 1421 is in an insertion cooperation with the limiting slot 17, the width of the restricting portion 1421 is greater than the maximum distance between the second limiting portion 152 and the locking portion 21. In this way, when the first slidable plug 14 is in the retracted state and the first drive member 142 is in the locked position, the restricting portion 1421 cannot pass through the space between the second limiting portion 152 and the locking portion 21, thereby preventing the first slidable plug 14 from being switched to the in-use state. Only when the first drive member 142 is switched to the unlocked position can the first slidable plug 14 be driven to switch from the retracted state to the in-use state, thereby preventing the first slidable plug 14 from switching to the in-use state when the plug adaptor 1 is shaken, such that it is easy for users to store the plug adaptor 1. It can be understood that when the first slidable plug 14 is switched to the in-use state, the first drive member 142 drives the second limiting portion and the locking member to slide via the connecting portion.

Further referring to FIGS. 2 and 4, in some embodiments of the present disclosure, the second limiting portion 152 has a first slope 1521 on an end near the first slidable plug 14. When the first slidable plug 14 slides to the in-use state, the first slidable plug 14 mates with the first slope 1521 to drive the second limiting portion 152 to slide along the first sliding direction. With this configuration, it is only required to provide the first slope 1521 on the second limiting portion 152 to associate the movement of the first drive member 142 extending out of the housing 11 with the movement of the second limiting portion 152 in the first sliding direction, thereby simplifying the overall structure of the plug adaptor 1.

Further referring to FIGS. 2 and 4, in some embodiments of the present disclosure, the locking portion 21 has a second slope 211 on an end near the first slidable plug 14. When the first slidable plug 14 slides to the in-use state, the first slidable plug 14 mates with the second slope 211 to drive the locking portion 21 to slide along the second sliding direction. With this configuration, it is only required to provide the second slope 211 on the locking portion 21 to associate the movement of the second drive member 162 extending out of the housing 11 with the movement of the locking portion 21 along the second sliding direction, thereby simplifying the overall structure of the plug adaptor 1.

Further referring to FIGS. 2 and 6, in some embodiments of the present disclosure, a third slope 212 is arranged on an end of the locking portion 21 near the second slidable plug 16. When the second slidable plug 16 slides into the in-use state, the second slidable plug 16 mates with the third slope 212 to drive the locking portion 21 to slide along the first sliding direction. With this configuration, it is only required to provide the third slope 212 on the locking portion 21 to associate the movement of the second drive member 162 extending out of the housing 11 with the movement of the locking portion 21 along the first sliding direction, thereby simplifying the overall structure of the plug adaptor 1.

Considering the longer length of EU-standard plug pins, the sliding of the EU-standard plug relative to the housing 11 causes the distance between the surface of the housing 11 away from the external socket and the external socket to be longer when the EU-standard plug is connected to the external socket, which results in the center of gravity of the plug adaptor being farther from the external socket, making the plug adaptor prone to falling off. In view of this, further referring to FIGS. 1 and 3, the rotatable plug 12 is an EU-standard plug. With this configuration, the distance between the surface of the housing 11 away from the external socket and the external socket is reduced when the EU-standard plug is connected to the external socket, thereby positioning the center of gravity of the plug adaptor closer to the external socket. This may ensure that the plug adaptor can be connected more stably to the external socket.

Referring to FIG. 2, in some embodiments of the present disclosure, the plug adaptor 1 further includes an electrical connection member 18 and a protective module 19. The electrical connection member 18 is arranged on the housing 11; the protective module 19 is arranged on the housing 11. When the rotatable plug 12 is in the in-use state, the rotatable plug 12 is electrically connected to the electrical connection member 18 via the protective module 19; when the rotatable plug 12 is in the retracted state, the rotatable plug 12 is electrically disconnected from the electrical connection member 18 via the protective module 19; when the first slidable plug 14 is in the in-use state, the second slidable plug 16 is electrically connected to the electrical connection member 18 via the protective module 19; when the second slidable plug 16 is in the retracted state, the second slidable plug 16 is electrically disconnected from the electrical connection member 18 via the protective module 19.

With this configuration, when the rotatable plug 12 is in the in-use state and connected to power, the first slidable plug 14 and the second slidable plug 16 in the retracted state are disconnected from the electrical connection member 18 via the protective module 19, thereby keeping the first slidable plug 14 and the second slidable plug 16 in a de-energized state, thus preventing users from being electrocuted when touching the first slidable plug 14 and the second slidable plug 16 in the retracted state, enhancing the safety of the plug adaptor 1. When the first slidable plug 14 is in the in-use state and connected to power, the second slidable plug 16 and the rotatable plug 12 in the retracted state are disconnected from the electrical connection member 18 via the protective module 19, thereby keeping the second slidable plug 16 and the rotatable plug 12 in a de-energized state, thus preventing users from being electrocuted when touching the second slidable plug 16 and the rotatable plug 12 in the retracted state, enhancing the safety of the plug adaptor 1. When the second slidable plug 16 is in the in-use state and connected to power, the first slidable plug 14 and the rotatable plug 12 in the retracted state are disconnected from the electrical connection member 18 via the protective module 19, thereby keeping the first slidable plug 14 and the rotatable plug 12 in a de-energized state, thus preventing users from being electrocuted when touching the first slidable plug 14 and the rotatable plug 12 in the retracted state, enhancing the safety of the plug adaptor 1.

There are various ways for the protective module 19 to be electrically connected to and disconnected from the electrical connection member 18. For example, the protective module 19 includes a slidable block, which is electrically connected to the rotatable plug 12. The slidable block can move vertically upward under the drive of the rotatable plug 12. When the rotatable plug 12 extends out of the housing 11, the rotatable plug 12 drives the slidable block to move toward the electrical connection member 18, thereby electrically connecting the slidable block to the electrical connection member 18. When the rotatable plug 12 retracts into the housing 11, the rotatable plug 12 drives the slidable block to move away from the electrical connection member 18, thereby disconnecting the slidable block from the electrical connection member 18.

Alternatively, the protective module 19 includes a rotatable plate, an end of which is electrically connected to the rotatable plug 12, and the other end of which can rotate toward or away from the electrical connection member 18 under the drive of the rotatable plug 12. When the rotatable plug 12 extends out of the housing 11, the rotatable plug 12 drives the rotatable plate to rotate, causing the other end of the rotatable plate to move toward the electrical connection member 18, thereby establishing electrical connection between the rotatable plate and the electrical connection member 18. When the rotatable plug 12 retracts into the housing 11, the rotatable plug 12 drives the rotatable plate to rotate, causing the other end of the rotatable plate to move away from the electrical connection member 18, thereby disconnecting the rotatable plate from the electrical connection member 18.

For another example, the protective module 19 is fixedly arranged on the first slidable plug 14 to move together with the first slidable plug 14. For clarity, the first slidable plug 14 moves upward to switch to the in-use state, in which case the electrical connection member 18 is disposed above the protective module 19. When the first slidable plug 14 moves upward to switch to the in-use state, the protective module 19 moves upward with the first slidable plug 14 to contact and be electrically connected to the electrical connection member 18. When the first slidable plug 14 moves downward to switch to the retracted state, the protective module 19 moves downward with the first slidable plug 14 to be disconnected from the electrical connection member 18.

The above is merely some embodiments of the present disclosure and is not intended to limit the scope of the present disclosure. Any modifications, equivalent replacements, or improvements made within the spirit and principles of the present disclosure should be included within the scope of the present disclosure.

1. A plug adaptor, comprising:
a housing;
a rotatable plug, arranged on the housing and rotatably connected to the housing via a rotating portion;
a first slidable plug, arranged on the housing and capable of sliding relative to the housing;
a second slidable plug, arranged on the housing and capable of sliding relative to the housing;
a limiting assembly, arranged within the housing; wherein the limiting assembly is capable of moving relative to the housing under an action of the rotatable plug or the first slidable plug; and
a locking assembly, arranged within the housing; wherein the locking assembly is capable of moving relative to the housing under an action of the first slidable plug or the second slidable plug;
wherein in a case where one of the rotatable plug, the first slidable plug, and the second slidable plug is in an in-use state, the other two of the rotatable plug, the first slidable plug, and the second slidable plug are in a retracted state, and the other two are locked in the retracted state by the limiting assembly and the locking assembly.

2. The plug adaptor according to claim 1, wherein the limiting assembly comprises a first limiting portion and a second limiting portion that is in transmission connection with the first limiting portion; in a case where the rotatable plug switches from the retracted state to the in-use state, the rotatable plug drives the first limiting portion to move, causing the first limiting portion to drive the second limiting portion to move, and the second limiting portion is enabled to be in limiting cooperation with the first slidable plug in the retracted state.

3. The plug adaptor according to claim 2, wherein in a case where the rotatable plug switches from the in-use state to the retracted state and the first slidable plug switches from the retracted state to the in-use state, the first slidable plug drives the second limiting portion to move, causing the second limiting portion to drive the first limiting portion to move, and the first limiting portion is enabled to be in limiting cooperation with the rotatable plug in the retracted state.

4. The plug adaptor according to claim 1, wherein the rotatable plug is rotatably connected to the housing via a rotating portion;
the plug adaptor further comprises a locking member, arranged within the housing and in transmission connection with the rotating portion;
in a case where the rotatable plug switches from the retracted state to the in-use state, the rotating portion drives the locking member to move, and the locking member is enabled to be in limiting cooperation with the limiting assembly;
in a case where the rotatable plug switches from the in-use state to the retracted state and the first slidable plug switches from the retracted state to the in-use state, the first slidable plug drives the limiting assembly to move, and the limiting assembly is enabled to be in limiting cooperation with the rotatable plug.

5. The plug adaptor according to claim 4, wherein the rotating portion comprises a crank drive portion, disposed on a side of the rotating portion near the locking member and being in transmission connection with the locking member;
wherein in a case where the rotatable plug switches from the retracted state to the in-use state, the crank drive portion drives the locking member to move to lock the limiting assembly, and the locking member is abutted between the crank drive portion and the limiting assembly.

6. The plug adaptor according to claim 5, wherein the rotatable plug further comprises:
a mating portion, disposed on a same side of the rotatable plug as the crank drive portion;
wherein in a case where the rotatable plug is in the retracted state and the first slidable plug is in the in-use state, the limiting assembly is in insertion cooperation with the mating portion.

7. The plug adaptor according to claim 4, wherein the limiting assembly defines a locking slot;
in a case where the first slidable plug is in the retracted state and the rotatable plug is in the in-use state, the locking member is in insertion cooperation with the locking slot, and the locking member is enabled to be in limiting cooperation with the limiting assembly.

8. The plug adaptor according to claim 7, wherein the locking member is arranged with a guide slope, and a surface of the locking slot facing the guide slope is arranged with a matching slope;
in a case where the rotatable plug is in the retracted state and the first slidable plug switches from the retracted state to the in-use state, the limiting assembly, via the matching slope, cooperates with the guide slope to drive the locking member to exit the locking slot.

9. The plug adaptor according to claim 2, wherein one of the first limiting portion and the second limiting portion is arranged with a drive portion, and the other of the first limiting portion and the second limiting portion defines an inclined sliding slot; the drive portion extends into the inclined sliding slot, and the first limiting portion and the second limiting portion are enabled to be in sliding cooperation via the drive portion and the inclined sliding slot.

10. The plug adaptor according to claim 1, wherein an end of the limiting assembly near the first slidable plug is arranged with a first slope; in a case where the first slidable plug slides to the in-use state, the first slidable plug cooperates with the first slope to drive the limiting assembly to slide.

11. The plug adaptor according to claim 1, wherein the locking assembly comprises:
a locking portion;
wherein in a case where the rotatable plug is in the in-use state, the limiting assembly locks the first slidable plug in the retracted state, the limiting assembly abuts against the locking portion, and the locking portion is enabled to lock the second slidable plug in the retracted state;
in a case where the first slidable plug is in the in-use state, the first slidable plug abuts against the limiting assembly, and the limiting assembly is enabled to lock the rotatable plug in the retracted state; and the first slidable plug abuts against the locking portion, and the locking portion is enabled to lock the second slidable plug in the retracted state;
in a case where the second slidable plug is in the in-use state, the locking portion locks the first slidable plug in the retracted state, the locking portion abuts against the limiting assembly, and the limiting assembly is enabled to lock the rotatable plug in the retracted state.

12. The plug adaptor according to claim 1, wherein the first slidable plug comprises:
a first slidable plug body, arranged in the housing and capable of sliding relative to the housing; and
a first drive member, in transmission connection with the first slidable plug body and partially extending outside the housing;
wherein the second slidable plug comprises:
a second slidable plug body, arranged in the housing and capable of sliding relative to the housing; and
a second drive member, in transmission connection with the second slidable plug body and partially extending outside the housing;
wherein in a case where the rotatable plug is in the in-use state, the limiting assembly blocks the first drive member, and the locking assembly blocks the second drive member, for locking the first slidable plug and the second slidable plug in the retracted state;
in a case where the first slidable plug is in the in-use state, the locking assembly blocks the second drive member, for locking the second slidable plug in the retracted state;
in a case where the second slidable plug is in the in-use state, the locking assembly blocks the first drive member, for locking the first slidable plug in the retracted state.

13. The plug adaptor according to claim 1, wherein the first slidable plug comprises:
a first slidable plug body, arranged in the housing and capable of sliding relative to the housing; and
a first drive member, partially extending outside the housing and slidably connected to the first slidable plug body to switch between an unlocked position and a locked position of the first drive member;
wherein the first drive member is configured to, in a case where the first drive member is pressed by an external force, switch from the locked position of the first drive member to the unlocked position of the first drive member;
in a case where the first slidable plug is in the retracted state and the first drive member is not pressed by an external force, the first drive member is in the locked position of the first drive member;
in a case where the first drive member is in the unlocked position of the first drive member, the first drive member is capable of driving the first slidable plug body to slide relative to the housing;
wherein the second slidable plug comprises:
a second slidable plug body, arranged in the housing and capable of sliding relative to the housing; and
a second drive member, partially extending outside the housing and slidably connected to the second slidable plug body to switch between an unlocked position and a locked position of the second drive member;
wherein the second drive member is configured to, in a case where the second drive member is pressed by an external force, switch from the locked position of the second drive member to the unlocked position of the second drive member;
in a case where the second slidable plug is in the retracted state and the second drive member is not pressed by an external force, the second drive member is in the locked position of the second drive member;
in a case where the second drive member is in the unlocked position of the second drive member, the second drive member is capable of driving the second slidable plug body to slide relative to the housing.

14. The plug adaptor according to claim 13, wherein, in a case where the first slidable plug is in the in-use state and the first drive member is not pressed by an external force, the first drive member is in the locked position of the first drive member;
in a case where the second slidable plug is in the in-use state and the second drive member is not pressed by an external force, the second drive member is in the locked position of the second drive member.

15. The plug adaptor according to claim 13, wherein the first drive member comprises a restricting portion, and at least one of the limiting assembly and the locking assembly defines a limiting slot;
in a case where the first drive member is in the locked position of the first drive member, the restricting portion is in insertion cooperation with the limiting slot;
in a case where the first drive member switches from the locked position of the first drive member to the unlocked position of the first drive member, the restricting portion exits the limiting slot to release limitation on the first drive member, and the first drive member is enabled to drive the first slidable plug body to slide relative to the housing.

16. The plug adaptor according to claim 13, wherein the first slidable plug further comprises:
an elastic member, elastically abutted between the first slidable plug body and the first drive member, for enabling the first drive member to have a tendency to switch from the unlocked position of the first drive member to the locked position of the first drive member.

17. The plug adaptor according to claim 11, wherein at least one of the following is satisfied:
an end of the locking portion near the first slidable plug is arranged with a second slope; in a case where the first slidable plug slides to the in-use state, the first slidable plug cooperates with the second slope to drive the locking portion to slide toward the second slidable plug; and
an end of the locking portion near the second slidable plug is arranged with a third slope; in a case where the second slidable plug slides to the in-use state, the second slidable plug cooperates with the third slope to drive the locking portion to slide toward the first slidable plug.

18. The plug adaptor according to claim 1, wherein the rotatable plug is an EU-standard plug.

19. A plug adaptor, comprising:
a housing;
a rotatable plug, arranged on the housing and rotatably connected to the housing;
a first slidable plug, arranged on the housing and capable of sliding relative to the housing;
a second slidable plug, arranged on the housing and capable of sliding relative to the housing;
a limiting assembly, arranged within the housing and capable of moving relative to the housing; and
a locking assembly, arranged within the housing and capable of moving relative to the housing; wherein,
in a case where the first slidable plug and the second slidable plug are in a retracted state and the rotatable plug switches from the retracted state to an in-use state, the limiting assembly and the locking assembly lock the first slidable plug and the second slidable plug in the retracted state;
in a case where the first slidable plug and the rotatable plug are in the retracted state and the second slidable plug switches from the retracted state to the in-use state, the limiting assembly and the locking assembly lock the first slidable plug and the rotatable plug in the retracted state;
in a case where the second slidable plug and the rotatable plug are in the retracted state and the first slidable plug switches from the retracted state to the in-use state, the limiting assembly locks the rotatable plug in the retracted state, and the locking assembly locks the second slidable plug in the retracted state.

20. A plug adaptor, comprising:
a housing;
a rotatable plug, arranged on the housing and rotatably connected to the housing via a rotating portion;
a first slidable plug, arranged on the housing and capable of sliding relative to the housing; and
a second slidable plug, arranged on the housing and capable of sliding relative to the housing;
wherein in a case where one of the rotatable plug, the first slidable plug, and the second slidable plug is in an in-use state, the other two of the rotatable plug, the first slidable plug, and the second slidable plug are in a retracted state.
